(19) United States
(12) Patent Application Publication
(10) Pub. No.: US 2016/0364227 A1
(43) Pub. Date: Dec. 15, 2016

(54) APPARATUS, METHOD, AND COMPUTER-READABLE MEDIUM

(71) Applicant: FUJITSU LIMITED, Kawasaki-shi (JP)

(72) Inventors: Norihiko Sakamoto, Yokohama (JP); Masayoshi Utaka, Yokohama (JP)

(73) Assignee: FUJITSU LIMITED, Kawasaki-shi (JP)

(21) Appl. No.: 15/172,702

(22) Filed: Jun. 3, 2016

(30) Foreign Application Priority Data
Jun. 9, 2015 (JP) 2015-116487

(51) Int. Cl. G06F 9/445; G06F 9/455

(52) U.S. Cl. CPC G06F 8/65; G06F 9/45558; G06F 2009/45562

(57) ABSTRACT

An apparatus includes a memory and a processor. The processor obtains physical resource information on a usage amount of a physical resource used by each of a plurality of virtual machines, classifies the plurality of virtual machines into one or more groups based on the obtained physical resource information, obtains application information on patch programs applied to the virtual machine, compares the application information between the virtual machines classified into a group, and extracts, based on the result of the comparing, a patch program to be applied to the virtual machine to which the extracted patch program is not applied although the extracted patch program is applied to other virtual machine classified into the same group with the virtual machine.

### CROSS-REFERENCE TO RELATED APPLICATION

This application is based upon and claims the benefit of priority of the prior Japanese Patent Application No. 2015-116487, filed on Jun. 9, 2015, the entire contents of which are incorporated herein by reference.

### FIELD

The present disclosure generally relates to an apparatus, a method, and a computer-readable medium storing computer-executable instructions for extracting a patch program desired to be installed.

### BACKGROUND

A provider who provides service for a user (hereinafter also simply referred to as a provider) builds an operation system, for example, on a virtual machine (VM) and causes the operation system to operate in order to provide various types of service for the user. For example, such provider provides the service for the user by causing an operating system (OS) or an application that has been installed in the VM to cooperate and operate as the operation system.

In addition, the provider installs a program (hereinafter also referred to as a patch program) for performing update or the like of an application in the VM in which the operation system operates, as appropriate. Therefore, the provider may perform, for example, modification or the like of a malfunction inherent in an application that operates as a part of the operation system.

Japanese Laid-open Patent Publication No. 2012-168710 and Japanese Laid-open Patent Publication No. 2014-013457 are examples of the related art.

### SUMMARY

According to an aspect of the invention, provided is an apparatus for extracting a patch program desired to be installed. The apparatus includes a memory, a processor coupled to the memory. The processor included in the apparatus is configured to obtain physical resource information that is information on a usage amount of a physical resource of a computer, the physical resource being used by each of a plurality of virtual machines in executing each of processes, the plurality of virtual machines being application targets of patch programs and being executed by the computer. The processor is configured to classify the plurality of virtual machines into one or more groups based on the obtained physical resource information, and obtains application information that is information on the patch programs applied to the virtual machines, for each of the one or more groups. And, the processor is configured to extract a first patch program included in the patch programs as a patch program to be applied to a virtual machine to which the first patch program is not applied when the obtained application information includes information indicating existence of a group including a virtual machine to which the first patch program is applied and a virtual machine to which the first patch program is not applied.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall configuration of an information processing system;

FIG. 2 is a diagram illustrating a specific example of a physical machine and a VM illustrated in FIG. 1;

FIG. 3 is a diagram illustrating a specific example of cluster analysis;

FIG. 4 is a diagram illustrating a specific example of the cluster analysis;

FIG. 5 is a diagram illustrating a specific example of the cluster analysis;

FIG. 6 is a diagram illustrating a specific example of the cluster analysis;

FIG. 7 is a diagram illustrating a specific example of the cluster analysis;

FIG. 8 is a diagram illustrating a specific example of the cluster analysis;

FIG. 9 is a diagram illustrating a hardware configuration of an information processing apparatus;

FIG. 10 is a functional block diagram of the information processing apparatus illustrated in FIG. 9;

FIG. 11 is a flowchart illustrating an outline of patch program extraction processing in a first embodiment;

FIG. 12 is a flowchart illustrating details of the patch program extraction processing in the first embodiment;

FIG. 13 is a flowchart illustrating details of the patch program extraction processing in the first embodiment;

FIG. 14 is a flowchart illustrating details of the patch program extraction processing in the first embodiment;

FIG. 15 is a diagram illustrating a specific example of usage rate information;

FIG. 16 is a diagram illustrating a specific example of maximum usage amount information;

FIG. 17 is a diagram illustrating a specific example of physical resource information;

FIG. 18 is a diagram illustrating a specific example of group information;

FIG. 19 is a diagram illustrating a specific example of application information; and

FIG. 20 is a diagram illustrating a specific example of recommendation information that has been output to an output device.

### DESCRIPTION OF EMBODIMENTS

As for the operation system described in the background, it is desirable that a provider is capable of grasping a patch program that has been installed in each of the VMs in order to manage the VM.

However, there is a case in which physical resources (a CPU, a memory, and the like of the physical machine in which the VM has been generated) allocated to each of the VMs are changed depending on the usage status or the like of the operation system. In addition, the number of VMs desired to be managed may become enormous depending on the scale of the operation system. Accordingly, there is a case in which it is difficult for the provider to grasp the status of the patch program that has been installed in the VMs accurately and identify a patch program desired to be newly installed in the VMs.

Therefore, in some aspects of the present disclosure, provided are solutions for extracting a patch program desired to be installed. Within the disclosure, the term “patch program” may include a piece of software designed to update a computer program or its supporting data, to fix or improve it.

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

[Configuration of an Information Processing System]

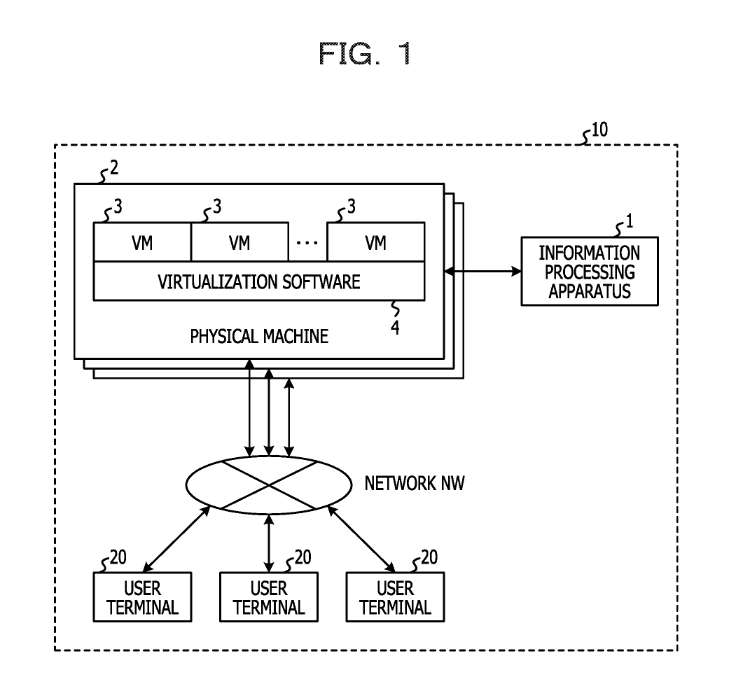

FIG. 1 is a diagram illustrating an overall configuration of an information processing system 10. The information processing system 10 illustrated in FIG. 1 includes an information processing apparatus 1 (hereinafter also referred to as a computer 1 or a patch program extraction device 1), a physical machine 2 (computer 2) in which VMs 3 are generated, and user terminals 20. The VM 3 may be accessed from the user terminal 20 through a network NW such as the Internet or an intranet.

The physical machine 2 is constituted by a plurality of physical machines in the example of FIG. 1, and each of the physical machines 2 includes physical resources such as a CPU and a memory. In addition, the resources of the physical machines 2 are allocated to a plurality of VMs 3.

The information processing apparatus 1 may access the VMs 3 and manage the VMs 3. For example, the information processing apparatus 1 performs, for example, management of patch programs (management of the type, the version, and the like of the patch programs) that have been installed in the VMs 3 generated in the physical machines 2. The information processing apparatus 1 may be built in a physical machine that is different from the physical machines 2, or may be built in a VM 3 generated in a physical machine 2.

The VM 3 is used, for example, to provide a user with infrastructure (hereinafter also referred to as a cloud service) through a network. The cloud service is the service by which an infrastructure on which a computer system is built and operated, that is, the infrastructure of a VM 3, a network, and the like are provided through the network. In addition, for example, the user accesses a cloud service portal site by using the user terminal 20, selects a specification desired for a VM, for example, a clock frequency of a CPU, a capacity (GB) of a memory, a capacity (MB/sec, IOPS) of a hard disk, and a communication bandwidth (Gbps) of a network, and concludes a cloud service contract for the specifications.

In the VM 3, for example, an operation system to provide service for the user is built. Therefore, the provider may provide various types of service for the user.

In addition, virtualization software 4 is infrastructure software that causes the VMs 3 to be operated by allocating physical resources of the physical machines 2 to the VMs 3 in response to an instruction from the information processing apparatus 1. The virtualization software 4 operates, for example, on the physical machines 2.

In the information processing system 10 illustrated in FIG. 1, an amount of physical resources allocated to each of the VMs 3 is changed depending on the operation status of the operation system built in the VMs 3. In addition, there is a case in which the number of VMs 3 to be managed becomes enormous depending on the scale of the operation system. Therefore, there is a case in which it is difficult for the provider to accurately grasp the status of the patch program installed in the VMs 3, and to identify a patch program to be newly installed in the VMs 3.

Therefore, the information processing apparatus 1 divides the VMs 3 generated in the physical machine 2 into groups, for example, by performing cluster analysis on the VMs 3. Specifically, the information processing apparatus 1 performs the cluster analysis using information indicating the operation status of each of the VMs 3 as an input. In addition, the information processing apparatus 1 compares the installation statuses of patch programs between the groups that have been obtained by the cluster analysis.

As a result, for example, the information processing apparatus 1 may obtain information on a difference between the installation statuses of patch programs in the VMs 3 classified into the same group. Therefore, when there is a patch program that is not installed in some VMs 3 from among the VMs 3 classified into the same group, for example, the information processing apparatus 1 may extract the patch program as a patch program to be installed. That is, in this case, it is unnecessary that the information processing apparatus 1 inspects in detail patch programs installed in all of the VMs 3. Therefore, even when the number of VMs 3 that are management targets is enormous, the information processing apparatus 1 may extract a patch program to be newly installed in a VM 3 relatively easily. A specific example of the cluster analysis is described in detail below.

[Specific Example of the Cluster Analysis]

A specific example of the cluster analysis is described below. The cluster analysis is a method in which targets having a similarity are identified from an aggregate including targets (hereinafter also referred to as analysis targets) having different properties and put into the same group. A specific example of a case is described below in which the information processing apparatus 1 performs the cluster analysis. A case is descried below in which the analysis targets are classified into two groups by performing the cluster analysis using a k-means method.

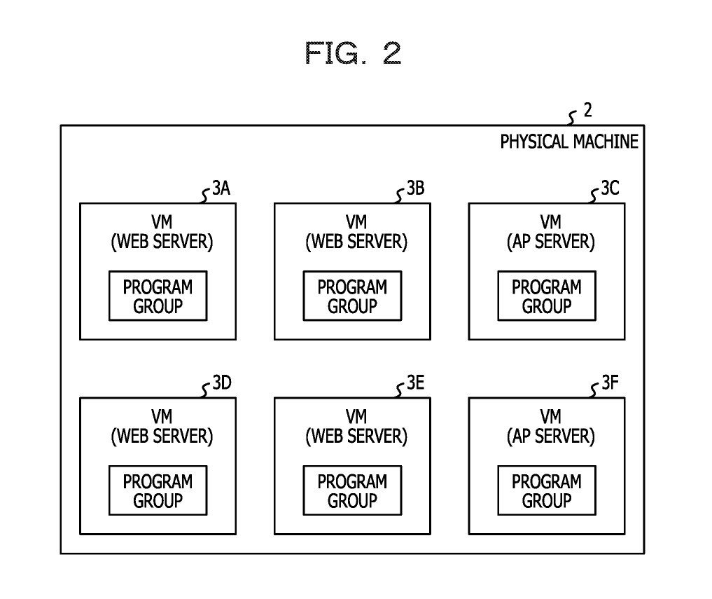

First, details of the VMs 3 illustrated in FIG. 1 are described. FIG. 2 is a diagram illustrating a detailed example of the VM 3 illustrated in FIG. 1. In the physical machine 2 illustrated in FIG. 2, VMs 3A, 3B, 3C, 3D, 3E, and 3F are generated. The VMs 3A, 3B, 3D, and 3E illustrated in FIG. 2 are VMs each of which functions as a Web server, and the VMs 3C and 3F illustrated in FIG. 2 are VMs each of which functions as an application server (hereinafter also simply referred to as an AP server). In addition, in each of the VMs illustrated in FIG. 2, a program (one or more programs) used to execute processing desired by the VM is installed.

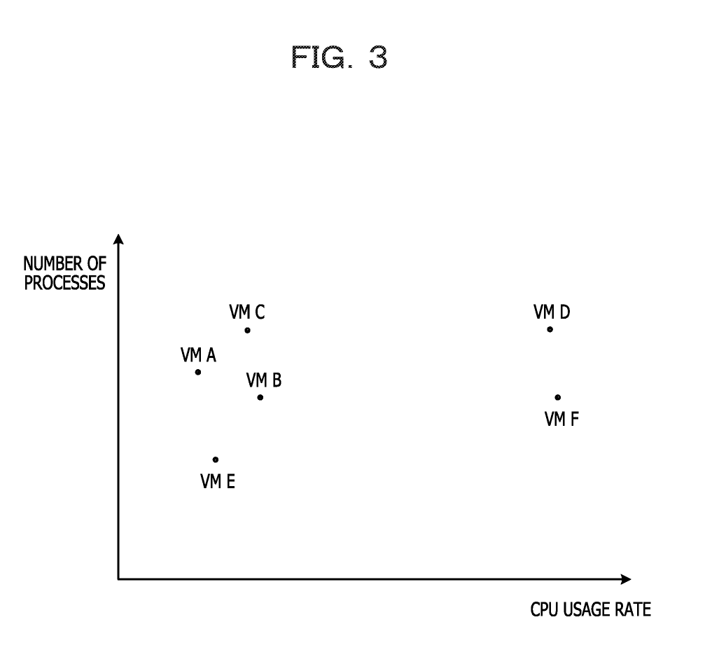

A specific example of a case is described below in which the information processing apparatus 1 performs the cluster analysis using the VM 3A, 3B, 3C, 3D, 3E, and 3F as analysis targets. FIGS. 3 to 8 are diagrams illustrating specific examples of the cluster analysis. Specifically, in a two-dimensional coordinate system illustrated in FIGS. 3 to 7, the horizontal axis indicates a usage rate of a CPU. In addition, in the two-dimensional coordinate system illustrated in FIGS. 3 to 7, the vertical axis indicates the number of processes started when a program installed in the VMs 3 is executed.

First, the information processing apparatus 1 obtains a usage rate of the CPU (for example, an average usage rate of the CPU) of the VMs 3 and the number of processes started (for example, the average number of processes started per unit time) when the program installed in the VMs 3 is executed. In addition, as illustrated in the two-dimensional coordinate system of FIG. 3, the information processing apparatus 1 sets a point corresponding to obtained information. Hereinafter, the points corresponding to the VMs 3A, 3B, 3C, 3D, 3E, and 3F on the graph are also simply referred to as points A, B, C, D, E, and F.

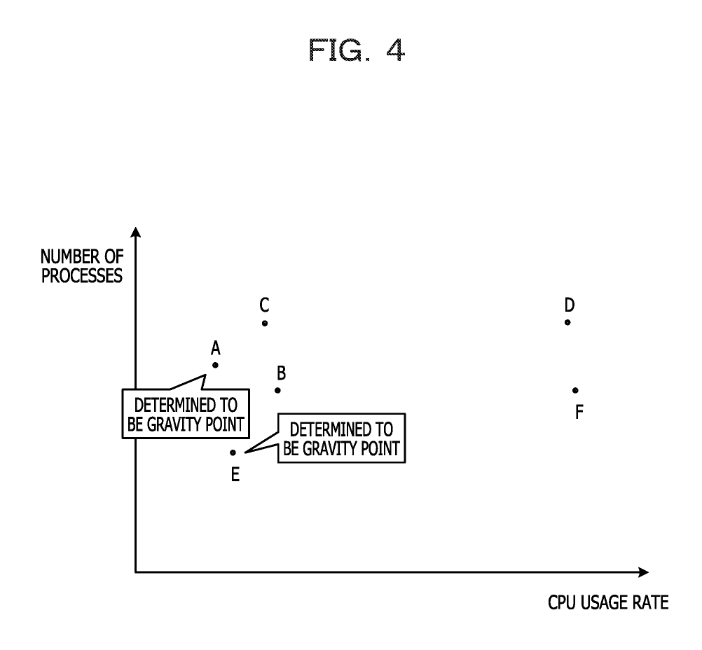

Next, the information processing apparatus 1 determines a point that is to be a gravity point (temporary gravity point) from among the points A, B, C, D, E, and F. Specifically, the information processing apparatus 1 randomly determines gravity points the number of which is the same as the number of groups obtained by grouping of the VMs 3. For example, the number of groups obtained by grouping of the VMs 3 may be determined by the provider and input to the information processing apparatus 1 in advance. In addition, as illustrated in the two-dimensional coordinate system of FIG. 4, the information processing apparatus 1 determines, for example, the points A and E as gravity points.

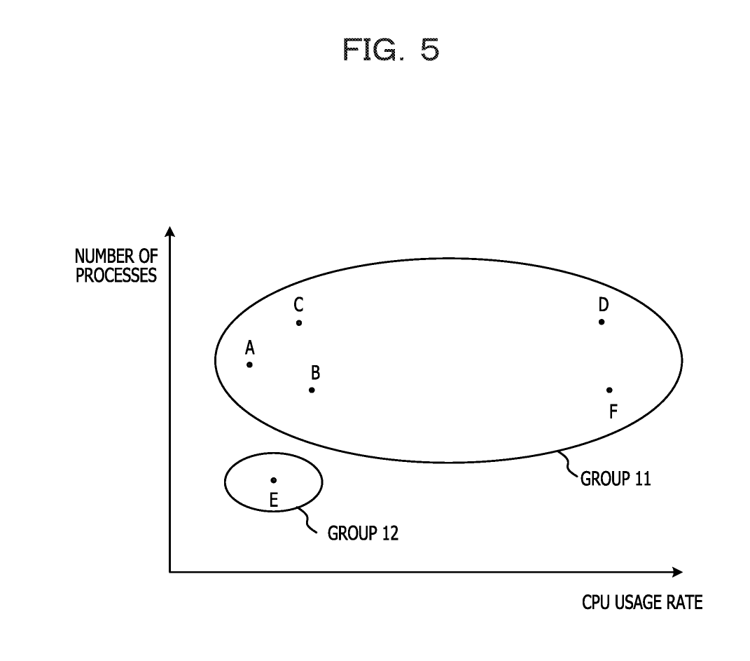

Next, the information processing apparatus 1 classifies the points A, B, C, D, E, and F into two groups. Specifically, the information processing apparatus 1 classifies the points B, C, D, and F that are points other than the points A and E that have been determined to be the gravity points, into a group including the point A or a group including the point E. In the two-dimensional coordinate system illustrated in FIG. 4, the points B, C, D, and F are set at the positions close to the point A as compared with the point E. Therefore, as illustrated in the two-dimensional coordinate system of FIG. 5, the information processing apparatus 1 classifies the points B, C, D, and F into the same group as the point A (hereinafter also referred to as a group 11). In addition, as illustrated in the two-dimensional coordinate system of FIG. 5, the information processing apparatus 1 does not classify the points other than the point E into the same group as the point E (hereinafter also referred to as a group 12).

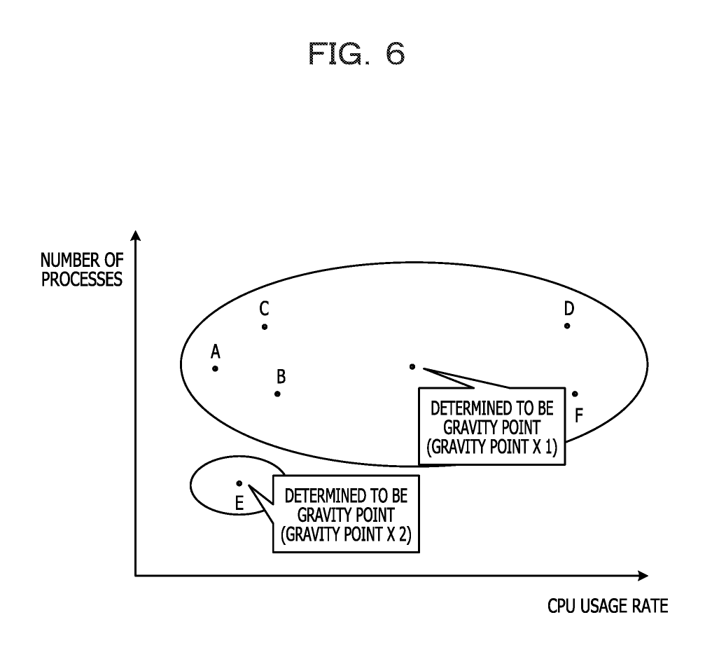

After that, as illustrated in FIG. 6, the information processing apparatus 1 determines a new gravity point in each of the groups 11 and 12. In this case, the information processing apparatus 1 sets, as a gravity point, the position of the center of gravity included in each of the groups, differently from the case described with reference to FIG. 4. Hereinafter, the new gravity point of the group 11 is also referred to as a gravity point X1, and the new gravity point of the group 12 is also referred to as a gravity point X2.

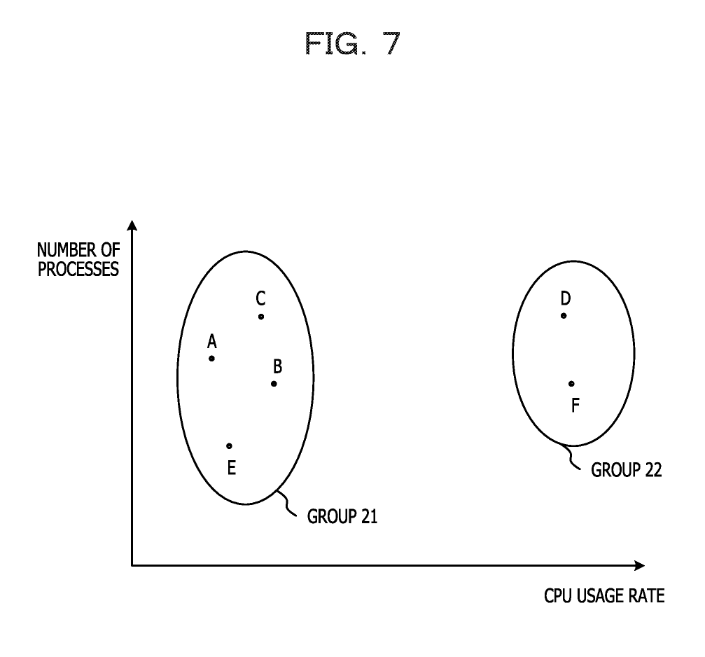

In addition, the information processing apparatus 1 performing again grouping of the points A, B, C, D, E, and F. In the two-dimensional coordinate system illustrated in FIG. 6, the points A, B, C, and E are set at the position closer to the gravity point X2 than to the gravity point X1. In addition, in the two-dimensional coordinate system illustrated in FIG. 6, the points D and F are set at the position closer to the gravity point X1 than to the gravity point X2. Therefore, as illustrated in the two-dimensional coordinate system of FIG. 7, the information processing apparatus 1 classifies the points A, B, C, and E into the same group (hereinafter also referred to as a group 21). In addition, as illustrated in the two-dimensional coordinate system of FIG. 7, the information processing apparatus 1 classifies the points D and F into the same group (hereinafter also referred to as a group 22).

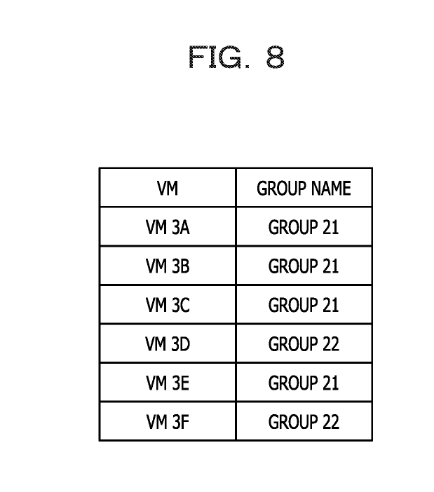

After that, the information processing apparatus 1 repeats the determination of gravity points illustrated in FIG. 6 and the grouping illustrated in FIG. 7 until a combination of points included in each of the two groups is not changed. As a result, the information processing apparatus 1 may divide the VMs 3A, 3B, 3C, 3D, 3E, and 3F into groups in each of which the operation statuses of the VMs are similar. For example, as illustrated in FIG. 8, the information processing apparatus 1 may divide the VMs into the group of the VMs 3A, 3B, 3C, and 3E and the group of the VMs 3D and 3F, separately. For example, when three types of information are used as an input of the cluster analysis, the information processing apparatus 1 sets a point corresponding to the information to a three-dimensional coordinate system. In this case, the information processing apparatus 1 performs the cluster analysis based on the information that has been set to the three-dimensional coordinate system.

Here, the result of the above-described grouping performed by the cluster analysis varies depending on content of the information that has been input when the cluster analysis is performed. That is, in the examples of FIGS. 2 to 8, when the accuracy of the information (the number of processes and the usage rate of the CPU) input to the information processing apparatus 1 is poor, the VMs may not be divided into groups in each of which the operation statuses of VMs are similar.

Specifically, in the examples of FIGS. 2 to 8, there is a case in which allocated physical resources (the number of cores of the CPU and the like) are different between VMs 3. In such a case, the average usage rates of the CPU which have been obtained from the VMs 3 by the information processing apparatus 1 may not reflect accurately the operation statuses of the VMs 3. Accordingly, the information processing apparatus 1 may not divide the VMs 3 into groups in each of which the operation statuses of VMs are similar.

Therefore, in the embodiment, the information processing apparatus 1 performs grouping of the plurality of VMs 3, based on information on the physical resources used by the plurality of VMs 3. In addition, the information processing apparatus 1 determines whether a group that includes a VM 3 to which a certain patch program (hereinafter also referred to as a first patch program) has been applied and a VM 3 to which the first patch program has not been applied exists or not. As a result, when the group that includes the VM 3 to which the first patch program has been applied and the VM 3 to which the first patch program has not been applied exists, the information processing apparatus 1 extracts the first patch program as a patch program to be applied to the VM 3 to which the first patch program has not been applied.

That is, the information processing apparatus 1 according to the embodiment obtains information on a usage amount of a physical resource (for example, a CPU) actually used by each of the VMs 3. Specifically, the information processing apparatus 1 obtains, for example, a maximum usage amount (maximum usable amount) of the CPU, which has been allocated to each of the VMs 3, in addition to the usage rate of the CPU by each of the VMs 3. The information processing apparatus 1 creates information on the physical resources which reflects the usage rate of the CPU by each of the VMs 3 and the maximum usage amount of the CPU that has been allocated to the VM 3.

As a result, the information processing apparatus 1 may perform grouping of the VMs 3, based on the created information on the physical resources. Therefore, the information processing apparatus 1 may extract a patch program desired to be applied to a VM 3, based on the information that reflects the operation status of each of the VMs 3. Thus, the information processing apparatus 1 may extract a patch program desired to be applied to the VM 3 with high reliability.

[Hardware Configuration of the Information Processing Apparatus]

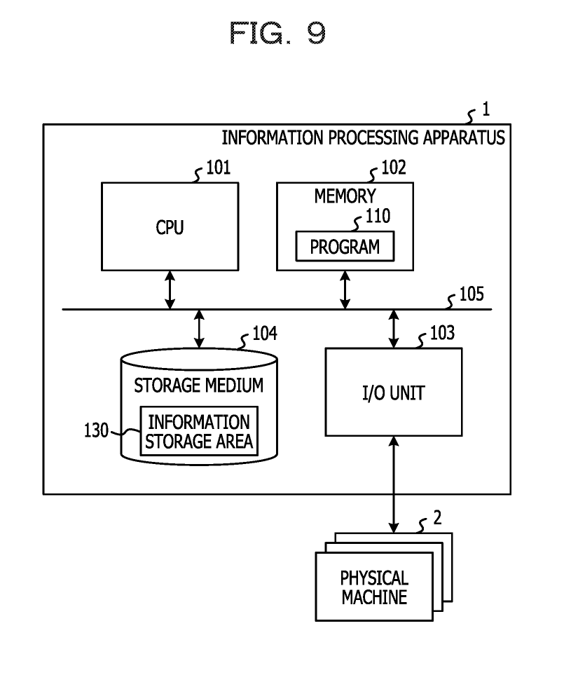

A hardware configuration of the information processing apparatus 1 is described below. FIG. 9 is a diagram illustrating the hardware configuration of the information processing apparatus 1.

The information processing apparatus 1 includes a CPU 101 that is a processor, a memory 102, an external interface (I/O unit) 103, and a storage medium 104. These units are coupled to each other through a bus 105.

The storage medium 104 stores a program 110 to execute processing (hereinafter also referred to as patch program extraction processing) of extracting a patch program to be applied to a VM 3, in a program storage area (not illustrated) of the storage medium 104.

As illustrated in FIG. 9, the CPU 101 loads the program 110 from the storage medium 104 to the memory 102 at the time of execution of the program 110, and executes the patch program extraction processing in cooperation with the program 110.

The storage medium 104 includes, for example, an information storage area 130 (hereinafter also referred to as a storage unit 130) that stores information used when the patch program extraction processing is executed. In addition, the external interface 103 communicates with the physical machine 2.

[Software Configuration of the Information Processing Apparatus]

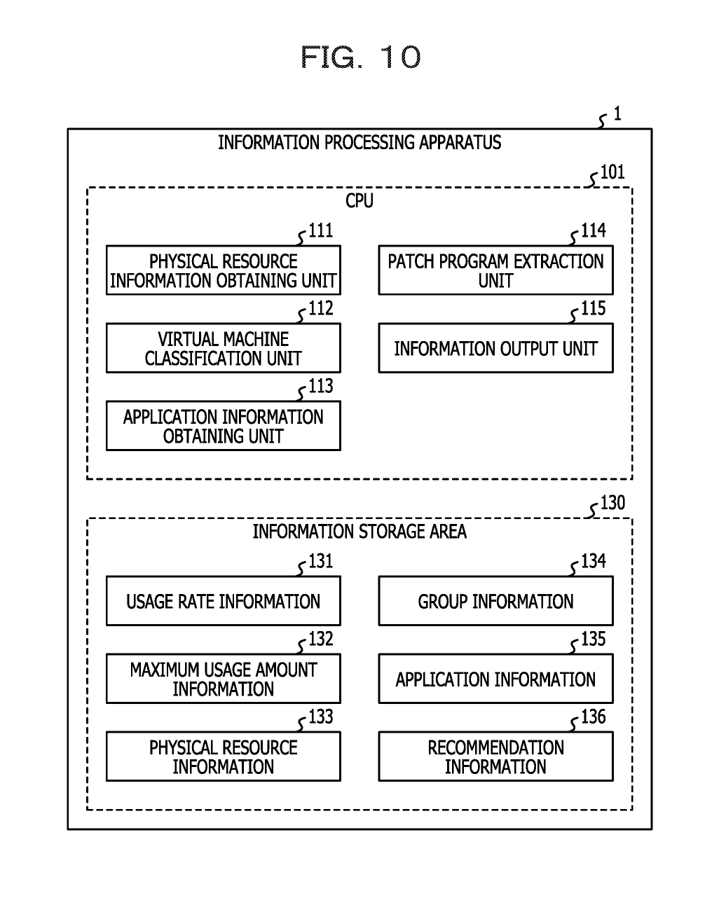

A software configuration of the information processing apparatus 1 is described below. FIG. 10 is a functional block diagram of the information processing apparatus 1 illustrated in FIG. 9. The CPU 101 operates as a physical resource information obtaining unit 111, a virtual machine classification unit 112, an application information obtaining unit 113, a patch program extraction unit 114, and an information output unit 115, in cooperation with the program 110. In addition, the information storage area 130 stores usage rate information 131, maximum usage amount information 132, physical resource information 133, group information 134, application information 135, and recommendation information 136.

The physical resource information obtaining unit 111 obtains the physical resource information 133 of each of the VMs 3. The physical resource information 133 is information on a usage amount of a physical resource used by each of the VMs 3 that are application targets of a patch program by execution of each process on the VM 3.

Specifically, the physical resource information obtaining unit 111 obtains, for example, the usage rate information 131 that is information on a usage rate of the CPU (for example, an average usage rate of the CPU in the execution of the process) by each of the VMs 3 when each of the processes is executed. In addition, the physical resource information obtaining unit 111 obtains, for example, the maximum usage amount information 132 that is a maximum usage amount (processing capability) per unit time (for example, 1 (sec)) of the CPU, which has been allocated to each of the VMs 3.

The physical resource information obtaining unit 111 obtains, for example, the physical resource information 133 that is information on a usage amount of the CPU per unit time when executing each of the processes, by multiplying the usage rate information 131 by the maximum usage amount information 132. After that, for example, the physical resource information obtaining unit 111 may store the usage rate information 131, the maximum usage amount information 132, and the physical resource information 133 in the information storage area 130. Specific examples of the usage rate information 131, the maximum usage amount information 132, and the physical resource information 133 are described later.

The virtual machine classification unit 112 classifies the VMs 3 that operate in the physical machine 2 into one or more groups, based on the physical resource information 133 obtained by the physical resource information obtaining unit 111. The virtual machine classification unit 112 classifies the VMs 3 into one or more groups, for example, by performing the cluster analysis described with reference to FIGS. 2 to 8. In addition, the virtual machine classification unit 112 stores in the information storage area 130, for example, the group information 134 that is information on the classified groups.

The application information obtaining unit 113 obtains the application information 135 that is information on a patch program that has been already applied to the VMs 3, for each of the groups obtained by the classification by the virtual machine classification unit 112. For example, the application information obtaining unit 113 may obtain the information on the patch program that has been applied to the VMs 3, for example, by performing inquiry about the patch program for a software vendor that provides the patch program. In addition, for example, the application information obtaining unit 113 stores in the information storage area 130 the application information 135 that is the obtained information.

The patch program extraction unit 114 determines whether the application information 135 obtained by the application information obtaining unit 113 includes information indicating the existence of a group that includes a VM 3 to which the first patch program has been applied and a VM 3 to which the first patch program is not applied. As a result, when the above-described information is included in the application information 135, the patch program extraction unit 114 determines that the first patch program is a patch program to be applied to the VM 3 to which the first patch program is not applied. The patch program extraction unit 114 performs extraction of the first patch program that has been determined to be a patch program to be applied.

The information output unit 115 outputs information on the first patch program extracted by the patch program extraction unit 114 (hereinafter also referred to as the recommendation information 136) to the user terminal 20 or an output device (not illustrated) of the information processing apparatus 1.

### Outline of a First Embodiment

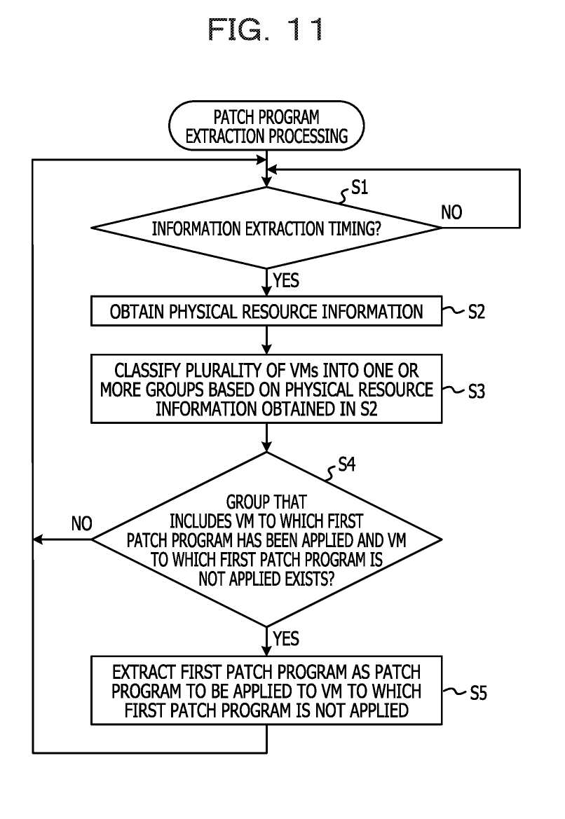

The outline of a first embodiment is described below. FIG. 11 is a flowchart illustrating the outline of the patch program extraction processing in the first embodiment.

First, the information processing apparatus 1 waits until information extraction timing as illustrated in FIG. 11 (NO in S1). The information extraction timing is timing at which the patch program extraction processing is executed. For example, the information extraction timing may be, for example, regularly set timing such as once a day.

After that, with the information extraction timing (YES in S1), the information processing apparatus 1 obtains the physical resource information 133 (S2). The information processing apparatus 1 then classifies a plurality of the VMs 3 into one or more groups, based on the physical resource information 133 obtained in S2 (S3).

That is, the physical resource information 133 is information on a usage amount of a physical resource that has been actually allocated to the VMs 3 by the physical machine 2. Therefore, the information processing apparatus 1 may perform grouping of the VMs 3 by comparing the operation statuses of the VMs 3 in equal conditions, based on the physical resource information 133.

In addition, the information processing apparatus 1 obtains the physical resource information 133 for each process in the processing of S2. The information processing apparatus 1 performs grouping of the VMs 3 based on the physical resource information 133 for each of the processes. Therefore, the grouping of the VMs 3 may be performed based on the detailed operation statuses of the VMs 3.

Therefore, the information processing apparatus 1 may cause VMs 3 the operation statuses of which are similar to each other to be included in the same group with high accuracy when the grouping of the VMs 3 is performed.

Next, the information processing apparatus 1 determines whether a group that includes a VM 3 to which the first patch program has been applied and a VM 3 to which the first patch program is not applied (S4) exists. The information processing apparatus 1 may determine whether a group that includes a VM 3 to which a patch program has been applied and a VM 3 to which the patch program is not applied exists, for example, for each of the whole patch programs to be managed.

As a result, when the information processing apparatus 1 determines that the group that includes both the VM 3 to which the first patch program has been applied and the VM 3 to which the first patch program is not applied exists (YES in S4), the information processing apparatus 1 determines that the first patch program is to be applied to the VM 3 to which the first patch program is not applied. In addition, the information processing apparatus 1 extracts the first patch program as a patch program to be applied to the VM 3 to which the first patch program is not applied (S5).

That is, the information processing apparatus 1 determines that the same patch program is assumed to be applied to the VMs 3 that have been classified into the same group. Therefore, when a VM 3 to which the first patch program has been applied and a VM 3 to which the first patch program is not applied exist in the same group, the information processing apparatus 1 determines that first patch program is desired to be applied to the VM 3 to which the first patch program is not applied. As a result, the information processing apparatus 1 may perform extraction of a patch program desired to be newly applied to a VM 3 by merely comparing application statuses of patch programs applied to the respective VMs 3 that have been classified into the same group.

When the information processing apparatus 1 determines that a group that includes both the VM 3 to which the first patch program has been applied and the VM 3 to which the first patch program is not applied does not exist (NO in S4), the information processing apparatus 1 does not execute the processing of S5.

As described above, in the first embodiment, the information processing apparatus 1 includes the physical resource information obtaining unit 111 that obtains the physical resource information 133 of each of the VMs 3. In addition, the information processing apparatus 1 includes the virtual machine classification unit 112 that classifies a plurality of VMs 3 into one or more groups, based on the obtained physical resource information 133.

In addition, the information processing apparatus 1 includes the application information obtaining unit 113 that obtains the application information 135 that is information on a patch program that has been applied to the VMs 3, for each of the groups. In addition, the information processing apparatus 1 includes the patch program extraction unit 114 that determines whether the obtained application information 135 includes information indicating the existence of a group including a VM 3 to which the first patch program has been applied and a VM 3 to which the first patch program is not applied. In addition, the patch program extraction unit 114 extracts the first patch program as a patch program to be applied to the VM 3 to which the first patch program is not applied, when the patch program extraction unit 114 has determined that the above-described information is included in the application information 135.

As a result, the information processing apparatus 1 may perform extraction of a patch program desired to be applied to a VM 3, based on the information on which the operation status in each of the VMs 3 has been reflected. Therefore, the information processing apparatus 1 may perform extraction of a patch program desired to be applied to a VM 3 with high reliability.

### Details of the First Embodiment

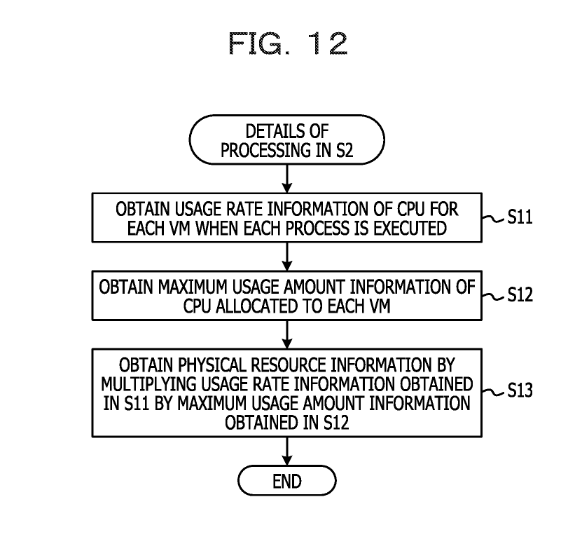

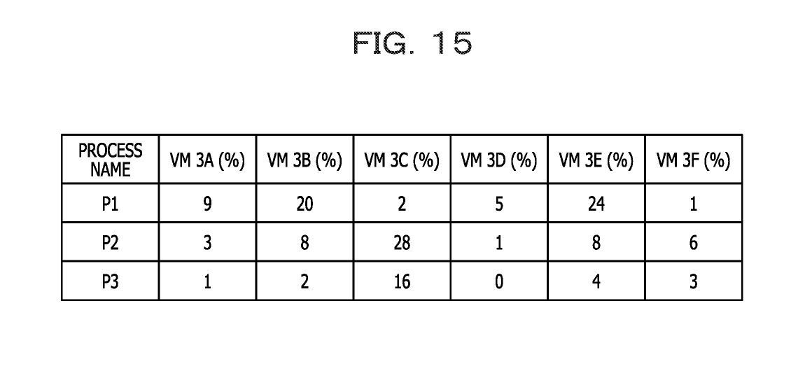

The details of the first embodiment are described below. FIGS. 12 to 14 are flowcharts each illustrating the details of the patch program extraction processing in the first embodiment. In addition, FIGS. 15 to 20 are diagrams each illustrating the details of the patch program extraction processing in the first embodiment. The patch program extraction processing illustrated in FIGS. 12 to 14 is described with reference to FIGS. 15 to 20.

[Details of the Processing of S2]

First, the details of the processing S2 in FIG. 11 are described. With the information extraction timing (YES in S1 of FIG. 11), the physical resource information obtaining unit 111 of the information processing apparatus 1 obtains the usage rate information 131 of the CPU of each of the VMs 3 (S11). Specifically, the physical resource information obtaining unit 111 obtains the usage rate information 131 of each of the VMs 3, for example, by accessing the VM 3. In addition, with the information extraction timing (YES in S1 of FIG. 11), the physical resource information obtaining unit 111 obtains the maximum usage amount information 132 of the CPU of each of the VMs 3 (S12). Specifically, the physical resource information obtaining unit 111 obtains the maximum usage amount information 132, for example, by accessing the physical machine 2 in which the VMs 3 have been generated. Specific examples of the usage rate information 131 and the maximum usage amount information 132 are described below.

FIG. 15 is a diagram illustrating a specific example of the usage rate information 131. The usage rate information 131 illustrated in FIG. 15 includes as an item “process name” to identify a process executed on VMs 3. In addition, the usage rate information 131 illustrated in FIG. 15 includes “VM 3A”, “VM 3B”, and “VM 3C” each indicating a usage rate of the CPU of the VM 3 when each process is executed. Similarly, the usage rate information 131 illustrated in FIG. 15 includes “VM 3D”, “VM 3E”, and “VM 3F” each indicating a usage rate of the CPU of the VM 3 when each of the processes is executed. Hereinafter, it is assumed that processes P1, P2, and P3 are operated in each of the VMs 3.

For example, in the usage rate information 131 illustrated in FIG. 15, to information “process name” of which is “P1”, “9(%)” is set to “VM 3A”, “20(%)” is set to “VM 3B”, and “2(%)” is set to “VM 3C”. In addition, in the usage rate information 131 illustrated in FIG. 15, to the information “process name” of which is “P1”, “5(%)” is set to “VM 3D”, “24(%)” is set to “VM 3E”, and “1(%)” is set to “VM 3F”. A description of other information included in FIG. 15 is omitted herein.

The usage rate information 131 illustrated in FIG. 15 is, for example, the information obtained by the physical resource information obtaining unit 111 accessing each of the VMs 3. However, CPU (for example, the number of cores of the CPU) allocated to VMs 3 by the physical machine 2 are different from each other depending on the VMs 3. Therefore, when grouping of the VMs 3 is performed merely with reference to the usage rate information 131, the virtual machine classification unit 112 may not perform the grouping of the VMs 3 so that the operation status (usage amount of the CPU or the like) of each of the VMs 3 is reflected on the grouping.

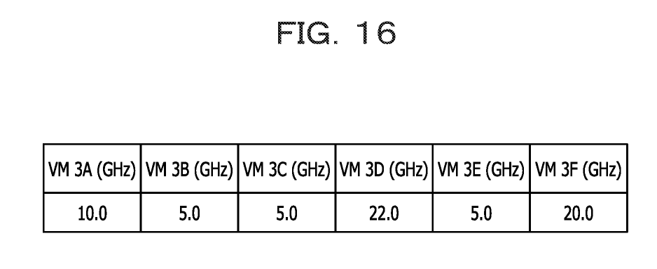

A specific example of the maximum usage amount information 132 is described below. FIG. 16 is a diagram illustrating a specific example of the maximum usage amount information 132. The maximum usage amount information 132 illustrated in FIG. 16 includes “VM 3A”, “VM 3B”, and “VM 3C” each indicating a maximum usage amount per unit time of the CPU that has been allocated to the VM 3 by the physical machine 2. Similarly, the maximum usage amount information 132 illustrated in FIG. 16 includes “VM 3D”, “VM 3E”, and “VM 3F” each indicating the maximum usage amount per unit time of the CPU that has been allocated to the VM 3 by the physical machine 2.

Specifically, in the maximum usage amount information 132 illustrated in FIG. 16, “10.0 (GHz)” is set to “VM 3A”, “5.0 (GHz)” is set to “VM 3B”, and “5.0 (GHz)” is set to “VM 3C”. In addition, in the maximum usage amount information 132 illustrated in FIG. 16, “22.0 (GHz)” is set to “VM 3D”, “5.0 (GHz)” is set to “VM 3E”, and “20.0 (GHz)” is set to “VM 3F”.

With reference to FIG. 12 again, the physical resource information obtaining unit 111 obtains the physical resource information 133 by multiplying the usage rate information 131 obtained in S11 by the maximum usage amount information 132 obtained in S12 (S13).

That is, the physical resource information obtaining unit 111 obtains the maximum usage amount information 132 described with reference to FIG. 16 in addition to the usage rate information 131 described with reference to FIG. 15. The physical resource information obtaining unit 111 obtains the physical resource information 133 based on the obtained usage rate information 131 and the maximum usage amount information 132. As a result, the virtual machine classification unit 112 may perform grouping of the VMs 3 based on the physical resource information 133 that reflects the usage rate information 131 and the maximum usage amount information 132, as described later. A specific example of the physical resource information 133 is described below.

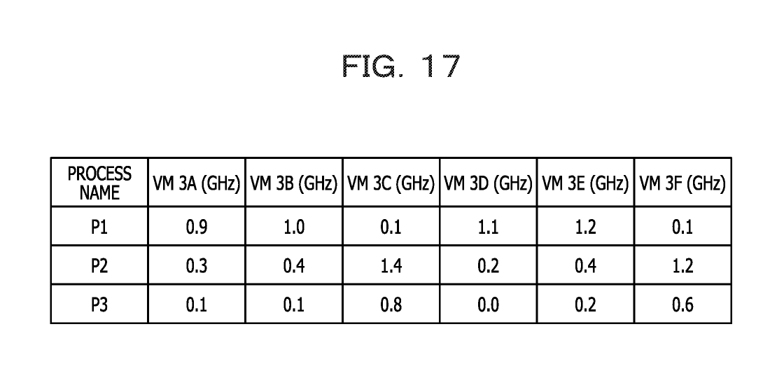

FIG. 17 is a diagram illustrating a specific example of the physical resource information 133. The physical resource information 133 illustrated in FIG. 17 includes as an item “process name” to identify a process executed on the VM 3. In addition, the physical resource information 133 illustrated in FIG. 17 includes “VM 3A”, “VM 3B”, and “VM 3C” each indicating a usage amount of the CPU when each of processes is executed. Similarly, the physical resource information 133 illustrated in FIG. 17 includes “VM 3D, “VM 3E”, and “VM 3F” each indicating a usage amount of the CPU when each of the processes is executed.

Specifically, in the physical resource information 133 illustrated in FIG. 17, to the information “process name” of which is “P1”, “0.9 (GHz)” is set to “VM 3A”, “1.0 (GHz)” is set to “VM 3B”, and “0.1 (GHz)” is set to “VM 3C”. In addition, in the physical resource information 133 illustrated in FIG. 17, to the information “process name” of which is “P1”, “1.1 (GHz)” is set to “VM 3D”, “1.2 (GHz)” is set to “VM 3E”, and “0.1 (GHz)” is set to “VM 3F”.

That is, the usage rate information 131 illustrated in FIG. 15 is information in which a difference between physical resources (CPU) that have been allocated to the VMs 3 by the physical machine 2 is not considered. Therefore, it is difficult for the virtual machine classification unit 112 to simply compare pieces of information for the respective VMs 3, which are included in the usage rate information 131 illustrated in FIG. 15 when the grouping of the VMs 3 is performed.

The physical resource information 133 illustrated in FIG. 17 is information that has been calculated by multiplying the usage rate information 131 by the maximum usage amount information 132, and is information on a usage amount of the CPU actually used by each of the VMs 3 when each of the processes is executed. Therefore, the virtual machine classification unit 112 may simply compare pieces of information included in the physical resource information 133 illustrated in FIG. 17 as described later, when the grouping of the VMs 3 is performed. Thus, the virtual machine classification unit 112 may perform the grouping of the VMs 3 with reference to the physical resource information 133 illustrated in FIG. 17. A description of other information included in the physical resource information 133 of FIG. 17 is omitted herein.

[Details of the Processing of S3]

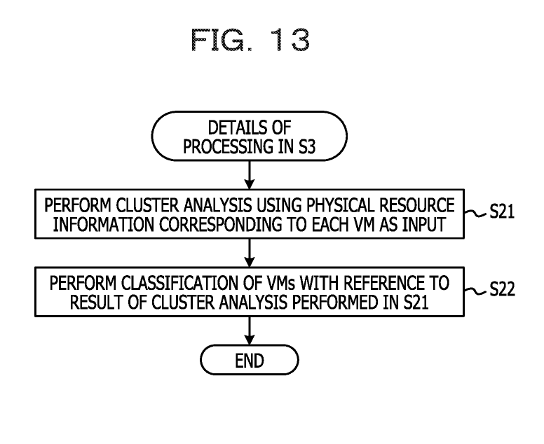

The details of the processing of S3 in FIG. 11 are described below. As illustrated in FIG. 13, the virtual machine classification unit 112 of the information processing apparatus 1 performs the cluster analysis using the physical resource information 133 corresponding to each of the VMs 3 as an input (S21). In addition, the virtual machine classification unit 112 performs grouping of the VMs 3 with reference to the result of the cluster analysis performed in S21 (S22).

In this case, the virtual machine classification unit 112 refers to, for example, the physical resource information 133 described with reference to FIG. 17. The virtual machine classification unit 112 sets, to a three-dimensional coordinate system for each of the VMs 3, a point in which a value corresponding to information “process name” of which is “P1” is set as an X coordinate, a value corresponding to information “process name” of which is “P2” is set as a Y coordinate, and a value corresponding to information “process name” of which is “P3” is set as a Z coordinate. For example, the virtual machine classification unit 112 sets a point in which the X coordinate is “0.9”, the Y coordinate is “0.3”, and Z coordinate is “0.1” to the three-dimensional coordinate system as a point corresponding to the VM 3A.

As described with reference to FIGS. 3 to 8, the virtual machine classification unit 112 performs the cluster analysis based on the information included in the three-dimensional coordinate system to which the point corresponding to the information of the physical resource information 133 in FIG. 17 has been set.

As a result, the virtual machine classification unit 112 may perform grouping of the VMs 3 so that the operation status of each of the VMs 3 is reflected on the grouping with high accuracy. A specific example of the group information 134 when information included in the physical resource information 133 illustrated in FIG. 17 is used as an input is described below.

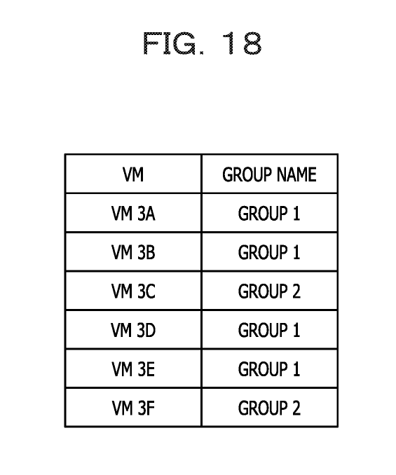

FIG. 18 is a diagram illustrating a specific example of the group information 134. The group information 134 illustrated in FIG. 18 includes as items “VM” to identify a VM 3 and “group” to identify a group including the VM 3.

Specifically, the group information 134 illustrated in FIG. 18 includes information indicating that the VMs 3A, 3B, 3D, and 3E are classified into a group 1, and the VMs 3C and 3F are classified into a group 2 as a result of the processing of S3 described with reference to FIGS. 11 and 13.

[Details of the Processing in S4 and S5]

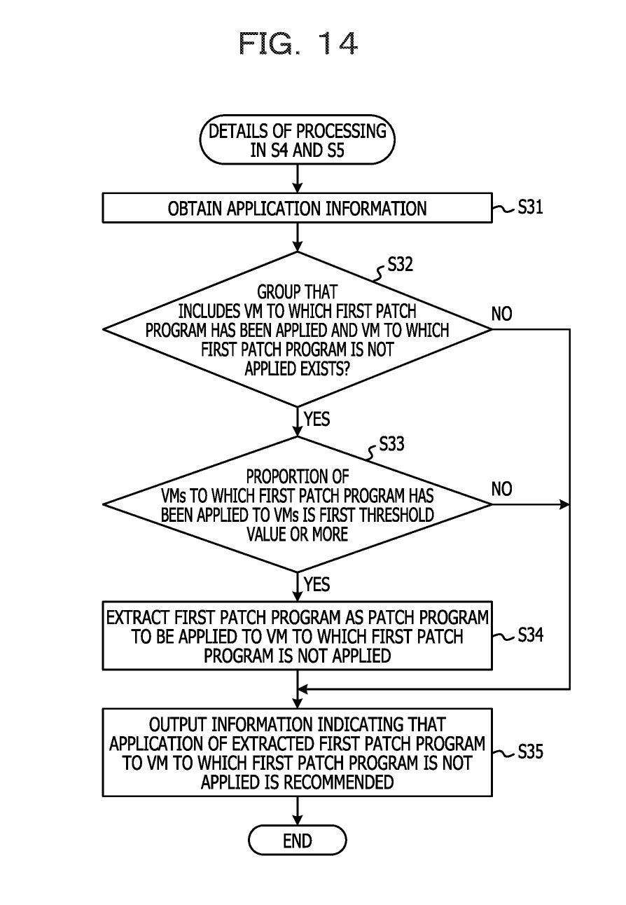

The details of the processing in S4 and S5 of FIG. 11 are described below. As illustrated in FIG. 14, the patch program extraction unit 114 of the information processing apparatus 1 obtains the application information 135 (S31). A specific example of the application information 135 is described below.

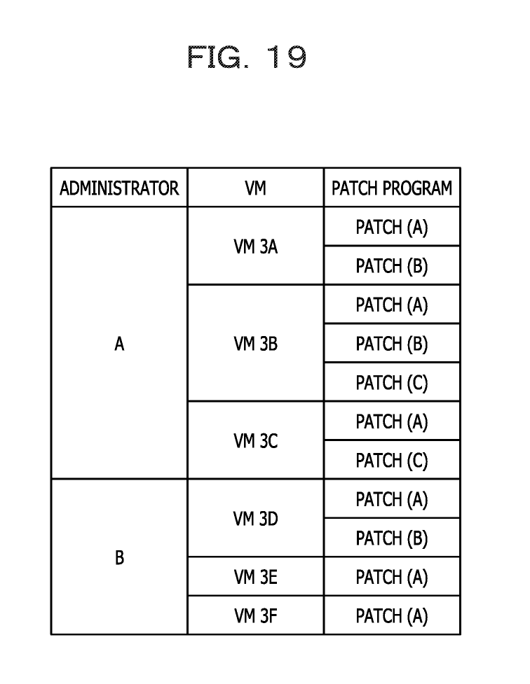

FIG. 19 is a diagram illustrating a specific example of the application information 135. The application information illustrated in FIG. 19 includes as items “administrator” to identify an administrator who manages a VM 3 and “VM” to identify the VM 3. In addition, the application information illustrated in FIG. 19 includes as an item “patch program” to identify a patch program that has been applied to the VM 3.

Specifically, the application information 135 illustrated in FIG. 19 includes, for example, information indicating that a patch program (A) (hereinafter also simply referred to as a patch (A)) and a patch program (B) (hereinafter also simply referred to as a patch (B)) are applied to the VM 3A. In addition, the application information 135 illustrated in FIG. 19 includes, for example, information indicating that the patch (A), the patch (B), and a patch program (C) (hereinafter also simply referred to as a patch (C)) are applied to the VM 3B. In addition, the application information 135 illustrated in FIG. 19 includes information indicating that an administrator of the VM 3A, 3B, and 3C is “A”, and an administrator of the VM 3D, 3E, and 3F is “B”.

That is, the patch program extraction unit 114 extracts a patch program desired to be newly applied to a VM 3, based on information included in the application information 135 as illustrated in FIG. 19 and information included in the group information 134 as illustrated in FIG. 18, as described later.

With reference to FIG. 14 again, the patch program extraction unit 114 determines whether a group that includes a VM 3 to which the first patch program has been applied and a VM 3 to which the first patch program is not applied exists, with reference to the application information 135 obtained in S31 (S32). That is, the patch program extraction unit 114 determines whether a group that includes the VMs 3 to which a patch program has been applied and a VM 3 to which the patch program is not applied exists, for example, for each of the patches (A), (B), and (C). The patch program extraction unit 114 may execute processing in S32 and subsequent steps, merely for some patch programs from among the patch programs that have been applied to the VMs 3.

In addition, when the patch program extraction unit 114 has determined that the above-described group exists (YES in S32), the patch program extraction unit 114 determines whether a proportion of the VMs 3 to which the first patch program has been applied to the VMs 3 included in the group is a first threshold value or more (S33). As a result, when the patch program extraction unit 114 has determined that the proportion of the VMs 3 to which the first patch program has been applied is the first threshold value or more (YES in S33), the patch program extraction unit 114 extracts the first patch program as a patch program to be applied to the VM 3 to which the first patch program is not applied (S34).

On the other hand, when a group that includes both the VM 3 to which the first patch program has been applied and the VM 3 to which the first patch program is not applied does not exist (NO in S32), the patch program extraction unit 114 does not executes the processing in S34. Similarly, when the patch program extraction unit 114 has determined that the proportion of the VMs 3 to which the first patch program has been applied is less than the first threshold value (No in S33), the patch program extraction unit 114 does not execute the processing of S34. A specific example of the processing of S32 to S34 is described below with reference to the group information 134 described in FIG. 18 and the application information 135 described in FIG. 19. Hereinafter, it is assumed that the first threshold value is 50(%).

[Specific Example of the Processing in S32 to S34]

The group information 134 illustrated in FIG. 18 includes information indicating that the VMs 3A, 3B, 3D, and 3E are classified into the group 1, and the VMs 3C and 3F are classified into the group 2. Therefore, the patch program extraction unit 114 performs extraction of a patch program for each of the groups.

For example, first, the patch program extraction unit 114 refers to information corresponding to the VMs included in the group 1 (VMs 3A, 3B, 3D, and 3E), from among pieces of information included in the application information 135 illustrated in FIG. 19. In addition, the patch program extraction unit 114 obtains information indicating that the patch (A) is applied to all of the VMs 3 included in the group 1. Therefore, the patch program extraction unit 114 determines that there is no VM 3 to which the patch (A) is to be newly applied from among the VMs 3 included in the group 1 (NO in S32). Thus, the patch program extraction unit 114 does not extracts the patch (A) as a patch program to be applied to a VM 3 to which the patch is not applied.

Next, the patch program extraction unit 114 obtains information indicating that the patch (B) is applied to the VMs 3A, 3B, and 3D from among the VMs 3 included in the group 1. Therefore, the patch program extraction unit 114 determines that the proportion of the VMs 3 to which the patch (B) has been applied to the VMs 3 included in the group 1 is 75(%) (YES in S32 and S33). Thus, the patch program extraction unit 114 extracts the patch (B) as a patch program to be applied to the VM 3E that is a VM to which the patch (B) is not applied (S34).

In addition, the patch program extraction unit 114 obtains information indicating that the patch (C) is applied to the VM 3B, from among the VMs 3 included in the group 1. Therefore, the patch program extraction unit 114 determines that the proportion of the VM 3 to which the patch (C) has been applied to the VMs 3 included in the group 1 is 25(%) (YES in S32 and NO in S33). Thus, the patch program extraction unit 114 does not extract the patch (C) as a patch program to be applied to the VMs 3 to which the patch is not applied.

Next, the patch program extraction unit 114 refers to information corresponding to the VMs included in the group 2 (VMs 3C and 3F), from among the pieces of information included in the application information 135 illustrated in FIG. 19. In addition, the patch program extraction unit 114 obtains information indicating that the patch (A) has been applied to all of the VMs 3 included in the group 2. Therefore, the patch program extraction unit 114 determines that there is no VM to which the patch (A) is to be newly applied, from among the VMs 3 included in the group 1 (NO in S32). Thus, the patch program extraction unit 114 does not extract the patch (A) as a patch program to be applied to a VM 3 to which the patch (A) is not applied.

In addition, the patch program extraction unit 114 obtains information indicating that the patch (C) is applied to the VM 3C, from among the VMs 3 included in the group 1. Therefore, the patch program extraction unit 114 determines that the proportion of the VM 3 to which the patch (C) has been applied to the VMs 3 included in the group 1 is 50(%) (YES in S32 and S33). Thus, the patch program extraction unit 114 extracts the patch (C) as a patch program to be applied to the VM 3E to which the patch is not applied (S34).

With reference to FIG. 14 again, the information output unit 115 outputs the recommendation information 136 that is information indicating that application of the first patch program extracted in S34 to the VM 3 to which the first patch program is not applied is recommended (S35). A specific example of the recommendation information 136 output to an output device (not illustrated) of the information processing apparatus 1 is described below.

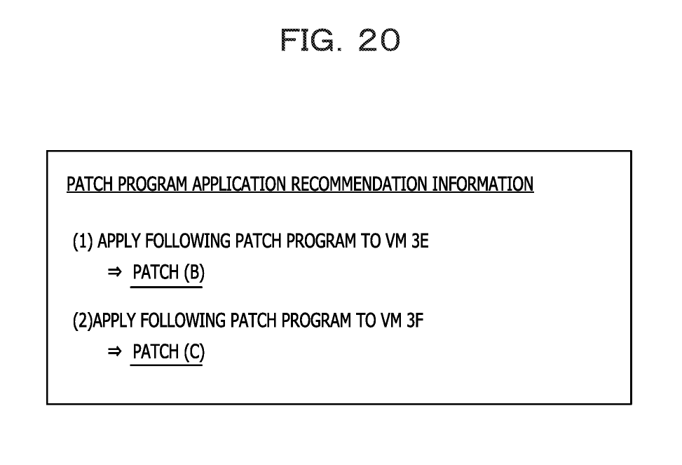

FIG. 20 is a diagram illustrating a specific example of the recommendation information 136 output to the output device. The recommendation information 136 illustrated in FIG. 20 includes, for example, information indicating that the patch (B) is to be applied to the VM 3E, and the patch (C) is to be applied to be the VM 3F.

As a result, the administrator of each of the VMs 3 (A or B in the example of FIG. 19) may obtain information on a patch program that is desired to be newly applied to a VM 3 managed by the administrator.

As described above, in the first embodiment, the information processing apparatus 1 includes the physical resource information obtaining unit 111 that obtains the physical resource information 133 of each of the VMs 3. In addition, the information processing apparatus 1 includes the virtual machine classification unit 112 that classifies a plurality of VMs 3 into one or more groups based on the obtained physical resource information 133.

In addition, the information processing apparatus 1 includes the application information obtaining unit 113 that obtains the application information 135 that is information on a patch program applied to the VMs 3, for each of the groups. In addition, the information processing apparatus 1 includes the patch program extraction unit 114 that determines whether the obtained application information 135 includes information indicating the existence of a group including a VM 3 to which the first patch program has been applied and a VM 3 to which the first patch program is not applied. When the patch program extraction unit 114 has determined that the above-described information is included in the obtained application information 135, the patch program extraction unit 114 extracts the first patch program as a patch program to be applied to the VM 3 to which the first patch program is not applied.

As a result, the information processing apparatus 1 may extract a patch program to be applied to a VM, based on information on which the operation status of each of VMs has been reflected accurately. Therefore, the information processing apparatus 1 may extract a patch program to be applied to a VM with high reliability.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory; and
a processor coupled to the memory and configured to
obtain physical resource information that is information on a usage amount of a physical resource of a computer, the physical resource being used by each of a plurality of virtual machines in executing each of processes, the plurality of virtual machines being application targets of patch programs and being executed by the computer,
classify the plurality of virtual machines into one or more groups based on the obtained physical resource information,
obtain application information that is information on the patch programs applied to the virtual machines, for each of the one or more groups, and
extract a first patch program included in the patch programs as a patch program to be applied to a virtual machine to which the first patch program is not applied when the obtained application information includes information indicating existence of a group including a virtual machine to which the first patch program is applied and a virtual machine to which the first patch program is not applied.

2. The apparatus according to claim 1, wherein
the physical resource information is information for each of the plurality of virtual machines and is calculated by multiplying a usage rate of a central processing unit (CPU) when each of the processes is executed by a maximum usage amount of the CPU, which is allocated to each of the plurality of virtual machines.

3. The apparatus according to claim 1, wherein
the processor is configured to perform cluster analysis using as an input the physical resource information corresponding to each of the plurality of virtual machines.

4. The apparatus according to claim 1, wherein
the processor is configured to extract the first patch program when the application information includes information indicating that a proportion of virtual machines to which the first patch program is applied to the plurality of virtual machines classified into the same group is a first threshold value or more.

5. The apparatus according to claim 1, wherein
the processor is configured to output information indicating that application of the extracted first patch program to a virtual machine to which the first patch program is not applied is recommended.

6. A method comprising:
obtaining physical resource information that is information on a usage amount of a physical resource of a computer, the physical resource being used by each of a plurality of virtual machines in executing each of processes, the plurality of virtual machines being application targets of patch programs and being executed by the computer;
classifying the plurality of virtual machines into one or more groups based on the obtained physical resource information;
obtaining application information that is information on the patch programs applied to the virtual machines, for each of the one or more groups; and
extracting, by a processor, a first patch program included in the patch programs as a patch program to be applied to a virtual machine to which the first patch program is not applied when the obtained application information includes information indicating existence of a group including a virtual machine to which the first patch program is applied and a virtual machine to which the first patch program is not applied.

7. The method according to claim 6, wherein
the physical resource information is information for each of the plurality of virtual machines and is calculated by multiplying a usage rate of a central processing unit (CPU) when each of the processes is executed by a maximum usage amount of the CPU, which is allocated to each of the plurality of virtual machines.

8. The method according to claim 6, wherein
the classifying a plurality of virtual machines includes performing cluster analysis using as an input the physical resource information corresponding to each of the plurality of virtual machines.

9. The method according to claim 6, wherein
the extracting a first patch program is performed when the application information includes information indicating that a proportion of virtual machines to which the first patch program is applied to the plurality of virtual machines classified into the same group is a first threshold value or more.

10. The method according to claim 6, further comprising:
performing output of information indicating that application of the extracted first patch program to a virtual machine to which the first patch program is not applied is recommended.

11. A non-transitory computer-readable medium for storing computer-executable program that cause a processor to execute a process, the process comprising:
obtaining physical resource information that is information on a usage amount of a physical resource of a computer, the physical resource being used by each of a plurality of virtual machines in executing each of processes, the plurality of virtual machines being application targets of patch programs and being executed by the computer;
classifying the plurality of virtual machines into one or more groups based on the obtained physical resource information;
obtaining application information that is information on the patch programs applied to the virtual machines, for each of the one or more groups; and
extracting a first patch program included in the patch programs as a patch program to be applied to a virtual machine to which the first patch program is not applied when the obtained application information includes information indicating existence of a group including a virtual machine to which the first patch program is applied and a virtual machine to which the first patch program is not applied.

12. The non-transitory computer-readable medium according to claim 11, wherein
the physical resource information is information for each of the plurality of virtual machines and is calculated by multiplying a usage rate of a central processing unit (CPU) when each of the processes is executed by a maximum usage amount of the CPU, which is allocated to each of the plurality of virtual machines.

13. The non-transitory computer-readable medium according to claim 11, wherein
the classifying a plurality of virtual machines includes performing cluster analysis using as an input the physical resource information corresponding to each of the plurality of virtual machines.

14. The non-transitory computer-readable medium according to claim 11, wherein
the extracting a first patch program is performed when the application information includes information indicating that a proportion of virtual machines to which the first patch program is applied to the plurality of virtual machines classified into the same group is a first threshold value or more.

15. The non-transitory computer-readable medium according to claim 11, wherein the procedure further comprising:
performing output of information indicating that application of the extracted first patch program to a virtual machine to which the first patch program is not applied is recommended.
